(19) United States
(12) Patent Application Publication
(10) Pub. No.: US 2020/0361318 A1
(43) Pub. Date: Nov. 19, 2020

(54) METHOD OF COAST REGENERATIVE BRAKE COOPERATION FOR A REAR WHEEL OF ENVIRONMENT-FRIENDLY VEHICLE

(71) Applicants: Hyundai Motor Company, Seoul (KR); Kia Motors Corporation, Seoul (KR)

(72) Inventors: Joung-Hee Lee, Hwaseong (KR); Ung-Hee Shin, Yeosu (KR); Gab-Bae Jeon, Hwaseong (KR); Jae-Hun Shim, Hwaseong (KR)

(21) Appl. No.: 16/692,274

(22) Filed: Nov. 22, 2019

(30) Foreign Application Priority Data
May 14, 2019 (KR) 10-2019-0056495
Aug. 30, 2019 (KR) 10-2019-0107350

(51) Int. Cl. B60L 7/18; B60L 7/26

(52) U.S. Cl. CPC B60L 7/18; B60T 8/26; B60L 7/26

(57) ABSTRACT

A method of coast regenerative brake cooperation control for rear wheels of an environment-friendly vehicle is provided. The method actively adjusts the generation amount of a braking force when distributing the braking force to front and rear wheels in response to reception of coast regeneration generation amount information that changes in real time.

### CROSS-REFERENCE TO RELATED APPLICATIONS

This application claims priority under 35 U.S.C. § 119 to Korean Patent Application No.10-2019-0056495, filed on May 14, 2019 and Korean Patent Application No.10-2019-0107350, filed on Aug. 30, 2019, with the Korean Intellectual Property Office, the disclosure of which is incorporated herein by reference in its entirety.

### BACKGROUND

### 1. Field of the Invention

The present invention relates to a method of coast regenerative brake cooperation control for rear wheels of an environment-friendly vehicle and, more particularly, to a method of coast regenerative brake cooperation control for rear wheels of an environment-friendly vehicle that actively adjusts the generation amount of a braking force when distributing the braking force to front wheels and rear wheels in response to reception of coast regeneration generation amount information that changes in real time.

### 2. Description of the Related Art

In general, regenerative brake cooperation control in environment-friendly vehicles (e.g., a hybrid vehicle, an electric vehicle, a fuel-cell vehicle, etc.) that perform regenerative brake on rear wheels is different in the situation of existing vehicles that perform regenerative brake only at front wheels. In environment-friendly vehicles that perform only front-wheel regenerative brake, a driving motor is disposed on the front wheels.

A regenerative brake force is generated and a braking force is applied only to front wheels when energy is restored by charging a battery using the driving motor. Even if the entire braking force that is applied to front wheel is greater, the possibility of spin of a vehicle spinning is low due to the regenerative braking force of the front wheels, and thus, the generation amount of a regenerative braking force may be maximally increased to restore maximum energy. However, in environment-friendly vehicles that perform regenerative brake on rear wheels, when a real-wheel regenerative braking force is increased to restore maximum energy, the rear wheels are locked first and the possibility of spin of a vehicle increases, and thus, there is a limit in increasing the regenerative braking force.

Meanwhile, when a regenerative braking force that is generated when an accelerator pedal and a brake pedal are disengaged exists, three types of braking forces including a coast regenerative braking force (e.g., coast regeneration) related by a driving controller, a rear-wheel regenerative braking force adjusted by a braking controller, and a friction braking force by hydraulic force simultaneously act in a vehicle. In particular, when the braking controller distributes the braking forces to the front wheels and the rear wheel without considering the coast regenerative braking force, the rear-wheel braking force becomes greater than the front-wheel braking force, and thus, the rear wheel may be locked earlier than the front wheel.

Accordingly, a technique in the related art has been developed to include: distributing a rear-wheel braking force only up to a rear-wheel limit braking force while distributing front-wheel and rear-wheel braking forces to generate a regenerative braking force for one or more of the front wheels and the rear wheels up to a reference deceleration ; and distributing the front-wheel and rear-wheel braking forces based on a set distribution ratio over the reference deceleration .

However, since the regenerative braking force of the front wheels is considered in this technique, it may be difficult to distribute the braking force in rear-wheel drive environment-friendly vehicles. Further, since the generation amount of the coast regenerative brake is fixed, the rear wheels may be locked first in a section with large magnitude of a deceleration.

### SUMMARY

The present invention may be made in an effort to provide a method of actively distributing braking forces of front wheels and rear wheels by changing a coast regenerative brake amount to prevent the rear wheels from being locked first even if the coast regenerative brake amount changes.

A method of coast regenerative brake cooperation control for rear wheels of an environment-friendly vehicle that adjusts braking forces of front wheels and rear wheels such that an S-braking value, which is the sum of a coast regenerative brake value and a rear-wheel regenerative brake value that are generated at the rear wheels, is adjusted within a critical value set in advance for each deceleration section, may include: a first section that is a section from an initial deceleration to a first reference deceleration and in which the S-braking value is adjusted such that a coast regenerative brake value that has been generated is fully allowed; a second section that is a section from the first reference deceleration to a second reference deceleration and in which the S-braking value is adjusted to decrease the coast regenerative brake value generated in the first section; and a third section that is a section from the second reference deceleration to a third reference deceleration and in which the S-braking value is adjusted to maintain or decrease the coast regenerative brake value decreased in the second section.

According to an exemplary embodiment of the present invention, the S-braking value may be calculated and compared with the critical value in real time in the first section to the third section. Additionally, the rear-wheel regenerative brake value may be increased in the first section. The rear-wheel regenerative brake value may be increased to prevent the S-braking value from exceeding the critical value in the second section.

The critical value may be set such that a wheel slip ratio that is generated at the rear wheels is within about 15%. The rear-wheel regenerative brake value may be increased to prevent the S-braking value from exceeding the critical value in the third section. Additionally, a front-rear-wheel braking distribution ratio of the third section may be adjusted to be a distribution ratio additionally considering a coast regenerative brake value adjusted in the second section to a basic distribution ratio.

Further, when the coast regenerative brake value is fully decreased in the second section, the front-rear-wheel braking distribution ratio of the third section may be adjusted to be the basic distribution ratio. The method may further include a fourth section in which a rear-wheel regenerative brake value generated in the third section may be adjusted to be converted into a rear-wheel friction braking force after the third reference deceleration .

According to the present invention, fuel efficiency may be improved by increasing the rear-wheel regenerative brake amount by distributing the rear-wheel regenerative brake in a low deceleration section or by decreasing the coast regenerative brake amount in a high deceleration section. According to the present invention, since it may be possible to previously decrease the coast regenerative brake amount, it may be possible to actively respond to driving situations by performing friction braking, etc. before a problem is generated with driving stability. In addition, since the S-braking value may be adjusted to be within a critical value, it may be possible to minimize the possibility of rear wheels being locked first and increase the driving stability.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is a braking diagram showing braking force distribution according to deceleration sections in an exemplary embodiment of the present invention;

FIG. 2 is a braking diagram showing distribution of braking forces of front wheels and rear wheels according to an S-braking line according to an exemplary embodiment of the present invention;

FIG. 3 is a braking diagram showing a state in which a coast regenerative brake amount generated in a first section of FIG. 1 has been reduced in a second section according to an exemplary embodiment of the present invention;

FIG. 4 is a braking diagram showing a state in which a coast regenerative brake amount generated in the first section of FIG. 1 has been fully reduced in the second section according to an exemplary embodiment of the present invention; and

FIG. 5 is a braking diagram showing distribution of braking forces of front wheels and rear wheels according to an S-braking line when a coast regenerative brake amount is not reduced in the second section according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereafter, exemplary embodiments of a method of coast regenerative brake cooperation control for rear wheels of an environment-friendly vehicle according to the present invention are described in detail with reference to drawings. The terms and words that are used hereafter should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The method of coast regenerative brake cooperation control for rear wheels of an environment-friendly vehicle according to an exemplary embodiment of the present invention improves braking stability and performance, and fuel efficiency of environment-friendly vehicles (e.g., a hybrid vehicle, an electric vehicle, and a fuel-cell vehicle, etc.) that perform regenerative brake on rear wheels.

A brake system for implementing the control method according to an exemplary embodiment of the present invention, which may independently control friction braking forces of front wheels and rear wheels, simultaneously adjusts a regenerative braking force and a friction braking force, and separates the operation of a brake pedal and generation of a braking force, may include a braking controller configured to adjust a friction braking force and a regenerative braking force.

In particular, the braking controller may be configured to acquire in real time coast regenerative brake amount (e.g., the generation amount of a regenerative braking force that is generated in coasting) information from a driving controller via controller area network (CAN) communication, etc. The braking controller receiving the information may be configured to transmit a control signal for adjusting coast regenerative torque, etc. to the driving controller, to adjust the coast regenerative brake amount.

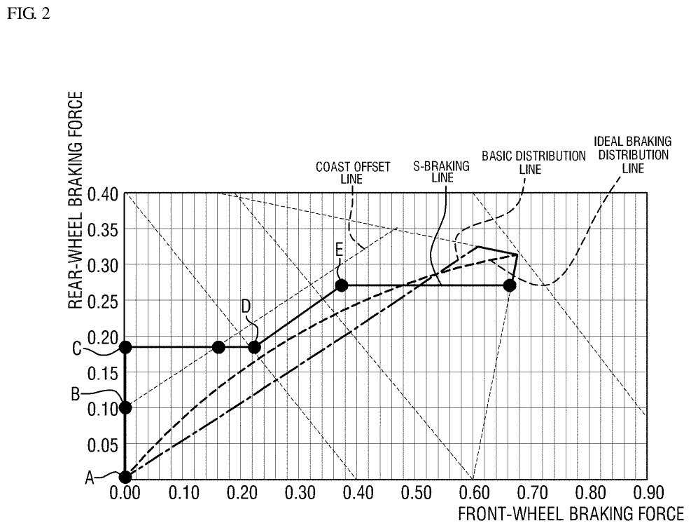

According to an exemplary embodiment of the present invention, the braking force shown in the figures is shown in the unit of deceleration (g). Basic distribution lines shown in FIGS. 2 to 5 are distribution lines set in consideration of the design elements of a brake unit when rear-wheel regenerative brake and coast regenerative brake are not generated. The distribution ratio of front wheels and rear wheels distributed by the basic distribution lines are referred to as a basic distribution ratio.

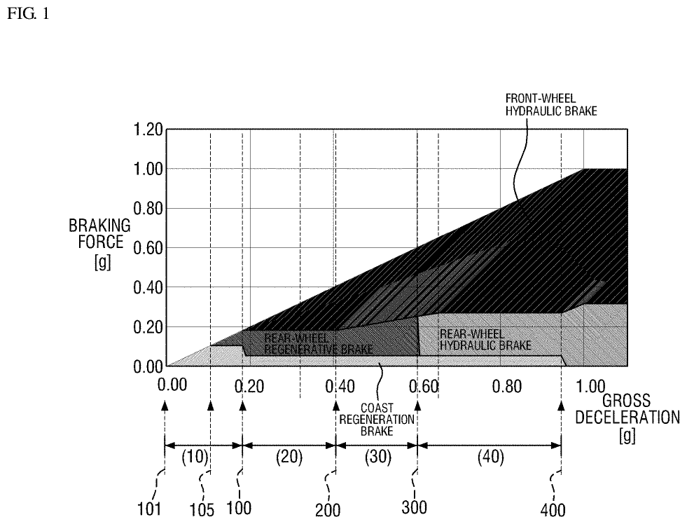

Referring to FIG. 1, a braking controller according to an exemplary embodiment of the present invention may be adjusted to receive coast regenerative brake amount information, which changes in real time, from a driving controller and to actively distribute front-wheel and rear-wheel braking forces based on deceleration sections in consideration of the received information. In other words, the braking controller according to an exemplary embodiment of the present invention may be configured to calculate in real time the sum of a coast regenerative brake amount that is generated at rear wheels and a rear-wheel regenerative brake amount that is generated in braking.

In this specification, the value of the coast regenerative brake amount is referred to as a coast regenerative brake value, the value of the rear-wheel regenerative brake amount is referred to as a rear-wheel regenerative brake value, and the sum of the coast regenerative brake value and the rear-wheel regenerative brake value is referred to as an S-brake value.

According to those shown in FIGS. 2 to 5, the S-brake value may be calculated in real time based on deceleration sections in the braking diagram, whereby it is shown as an S-braking line.

The braking controller may be configured to adjust the S-brake value to be within a predetermined critical value for each deceleration section, and distribute braking forces of front wheels and rear wheels based on the S-braking line. The critical value may be determined within a limit in which over-braking is not generated on rear wheels and may be appropriately set for each vehicle in consideration of the design elements of a brake unit. The critical value according to an exemplary embodiment of the present invention may be set such that the wheel slip ratio that is generated at rear wheels is within about 15%, but is not necessarily limited thereto.

The braking controller according to an exemplary embodiment of the present invention may be configured to store braking map data according to those shown in FIGS. 1 to 4, receive in real time a brake value that is generated in braking based on deceleration sections, and compare the received brake value and values of the braking map data. When the S-brake value is about equal to or greater than the critical value, the braking controller may be configured to decrease the coast regenerative brake value.

The method of coast regenerative brake cooperation control for rear wheels of an environment-friendly vehicle according to an exemplary embodiment of the present invention may include a first section 10, a second section 20, a third second 30, and a fourth section 40 distinguished based on the magnitude of a deceleration. In other words, according to an exemplary embodiment of the present invention, the deceleration section may be divided in accordance with the value of a reference deceleration from a first section 10 that is a low deceleration section and a fourth section 40 that is a high deceleration section. However, the value of a reference deceleration shown in FIG. 1 is an example and the value of the reference deceleration that determines deceleration sections may be set in various ways.

The first section 10 is a section from an initial deceleration 101 to a first reference deceleration 100 based on the magnitude of a deceleration, and a first coast regenerative brake value that has been generated already exists in a vehicle that is being driven in the first section 10. Meanwhile, the initial deceleration 101 is 0 in an exemplary embodiment of the present invention. The first coast regenerative brake value is fully allowed in the first section 10. When a brake pedal is engaged in the first section 10, a rear-wheel regenerative brake value is added to the first coast regenerative brake value. Accordingly, the first section 10 is a section in which a braking force may be distributed to rear wheels without being distributed to front wheels.

Meanwhile, according to those shown in FIGS. 2 to 5, a coast offset line is shown based on the first coast regenerative brake value generated in the first section 10 in the braking diagram. The slope of the coast offset line is the same as the slope of the basic distribution line. Referring to FIGS. 2 to 5, the first section 10, which is a section from a point A to a point C, is a section in which a braking force may be adjusted such that a rear-wheel braking force is distributed and a front-wheel braking force is not distributed. The point A is the S-brake value at the initial deceleration 101, the point B is the S-brake value at the first-first reference deceleration 105, and the point C is the S-brake value at the first reference deceleration 100.

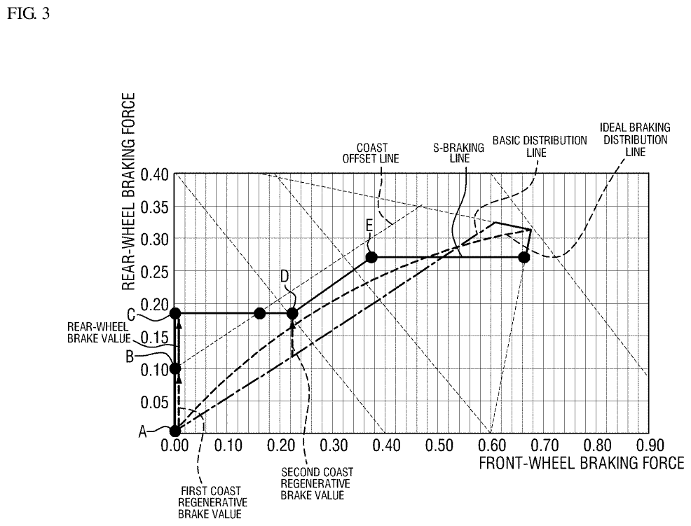

Referring to FIG. 3, in the first section 10, the section from the point A to the point B is a section in which the first coast regenerative brake value has been generated, and the section from the point B to the point C is a section in which the rear-wheel regenerative brake value has been generated. As described above, the S-brake value generated in the section from the point A to the point C may be adjusted to be within a critical value set in advance in the first section 10. In other words, the rear-wheel regenerative brake value in the first section 10 increases with a limit when the S-brake value and the critical value become the same. Particularly, the critical value of the first section 10 may be set within a range in which rear wheels may be prevented from locking earlier than front wheels. Rear-wheel regenerative braking may be performed in the first section 10, whereby fuel efficiency may be improved.

The second section 20 is a section from the first reference deceleration 100 to the second reference deceleration 200 based on the magnitude of the deceleration, and a front-wheel hydraulic brake value exists after the second section 20. The second section 20 is a section in which the first coast regenerative brake value generated in the first section 10 may be decreased. In general, when a vehicle is coasting, the coast regenerative brake amount may be set to increase the energy restoration ratio or the coast regenerative brake amount may be set low for driving stability. When the coast regenerative brake amount is set to increase the energy restoration ratio and the friction coefficient of a road is small such as a snowy road, an icy road, and a rainy road, rear driving wheels may slip due to coast regenerative brake.

Accordingly, the first coast regenerative brake value generated in the first section 10 decreases in the second section 20 according to an exemplary embodiment of the present invention. Referring to FIGS. 2 to 4, the second section 20, which is a section from the point C to the point D, is a section in which the first coast regenerative brake value may be decreased to become a second coast regenerative brake value. The point D is an S-brake value at the second reference deceleration 200.

According to FIG. 1, in the second section 20 according to an exemplary embodiment of the present invention, the point in time of reduction of the first coast regenerative brake value is the point in time when the first reference deceleration 100 is reached. However, reduction of the first coast regenerative brake value is allowed to be generated at any position in the second section 20.

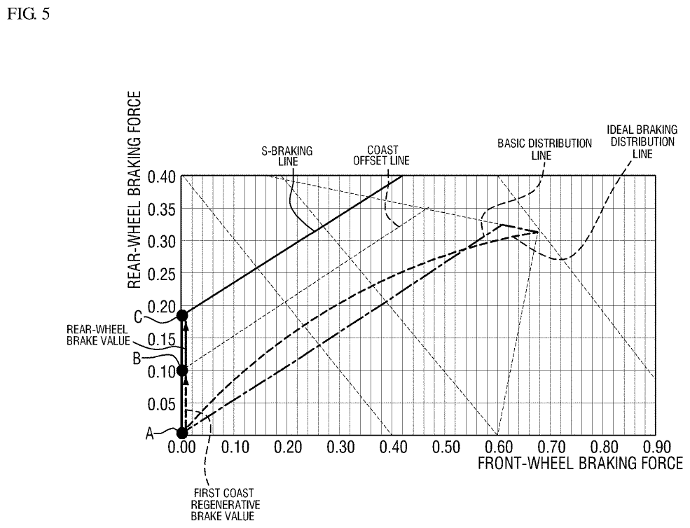

Referring to FIG. 5, if the first coast regenerative brake value is not decreased in the second section 20, the S-brake value generated in the first section 10 is added to the S-braking line shown from the second section 20, and thus, the S-braking line is shown with the slope of the basic distribution line in the braking diagram. Accordingly, when braking is distributed to front wheels and rear wheels based on the increased S-braking line, the rear wheels may be locked first.

Referring to FIGS. 2 and 3, the first coast regenerative brake value generated in the first section 10 decreases in the second section 20, and when the second reference deceleration 200 is reached, a second coast regenerative brake value with the first coast regenerative brake value reduced is shown in the braking diagram. The rear-wheel regenerative brake value increases in the second section 20. The reason of an increase of the rear-wheel regenerative brake value is for improving fuel efficiency by performing regenerative brake.

As described above, the S-braking value generated in the section from the point C to the point D may be adjusted to be within a critical value set in advance in the second section 20. In other words, the rear-wheel regenerative brake value in the second section 20 increases with a limit when the S-braking value and the critical value become the same. Particularly, the critical value of the second section 20 may be set within a range in which rear wheels may be prevented from locking earlier than front wheels.

The S-braking line may be maintained constantly in the second section 20 according to an exemplary embodiment of the present invention since the increased rear-wheel regenerative brake value is the same as the difference between the first coast regenerative brake value and the second coast regenerative brake value. However, when the S-braking value in the second section 20 is within the critical value, the S-braking line does not need to be maintained constantly.

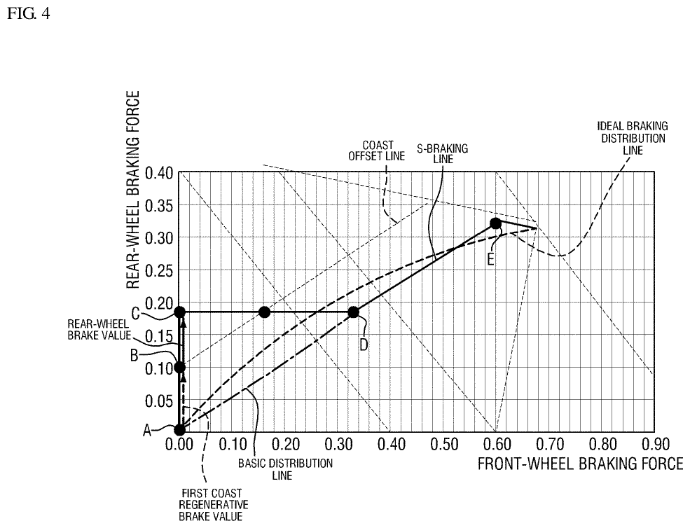

As shown in FIG. 4, when the first coast regenerative brake value decreases and the second coast regenerative brake value becomes 0 in the second section 20, the S-braking line meets the basic distribution line at the point D. Referring to FIGS. 2 to 4, the first coast regenerative brake value has decreased through the coast offset line. In other words, in the braking diagram, the difference between the coast offset line and the basic distribution line is the first coast regenerative brake value, and the second coast regenerative brake value is under the coast offset line, and thus, the first coast regenerative brake value decreases in the second section 20.

A third section 30, which is a section from the second reference deceleration 200 to the third reference deceleration 300 based on the magnitude of the deceleration, is a section in which the second coast regenerative brake value decreased in the second section 20 may be adjusted. Although the second coast regenerative brake value is maintained in the third section 30 according to an exemplary embodiment of the present invention, the second coast regenerative brake value may decrease in the third section 30 according to another exemplary embodiment of the present invention.

Referring to FIGS. 2 to 4, the third section 30 is the section from the point D to the point E, in which the second coast regenerative brake value is added to the S-braking line and the S-braking line increases with the slope of the basic distribution line. In particular, the point E is an S-braking value at the third reference deceleration 300. The rear-wheel regenerative brake value increases in the third section 30. The reason of an increase of the rear-wheel regenerative brake value is for improving fuel efficiency by performing regenerative brake.

As described above, the S-braking value generated in the section from the point D to the point E may be adjusted to be within a critical value set in advance in the third section 30. In other words, the rear-wheel regenerative brake value in the third section 30 increases with a limit when the S-braking value and the critical value become the same. Particularly, the critical value of the third section 30 may be set within a range in which rear wheels may be prevented from locking earlier than front wheels.

Referring to FIG. 3, when the second coast regenerative brake value exists, the S-braking line increases with the slope of the basic distribution line from the second coast regenerative brake value in the third section 30. Further, referring to FIG. 4, when the second coast regenerative brake value is 0, the S-braking line in the third section 30 is the same as the basic distribution line.

A fourth section 40 is a section from the third reference deceleration 300 to the fourth reference deceleration 400 based on the magnitude of the deceleration, and in the fourth section 40, the rear-wheel regenerative brake force generated in the third section 30 is off (e.g., brake pedal is disengaged) and a rear-wheel hydraulic braking force may be adjusted to be generated to control hydraulic brake to be generated based on driving stability rather than fuel efficiency in the fourth section 40 that is a high deceleration section.

Meanwhile, the point in time when the rear-wheel regenerative braking force is off in the fourth section 40 according to an exemplary embodiment of the present invention is the point in time when the third reference deceleration 300 is reached. However, the rear-wheel regenerative braking force is allowed to be off at any position in the fourth section 40. On the other hand, electronic brake force distribution (EBD) that appropriately adjusts braking force distribution to prevent excessive over-braking of rear wheels may be possible in the deceleration section after the fourth section 40.

Referring to FIGS. 2 to 5, the S-braking line is shown to be larger than an ideal braking distribution line in the first section 10 to the third section 30 according to an exemplary embodiment of the present invention, but it may be possible to set the S-braking line to be close to the ideal braking distribution line or to be lower than the ideal braking distribution line by adjusting the S-braking value, as described above.

As described above, according to an exemplary embodiment of the present invention, it may be possible to improve fuel efficiency by actively adjusting the coast regenerative brake value and the rear-wheel regenerative brake value in the first section 10 to the third section 30.

Although the present invention was described with reference to limited exemplary embodiments and drawings, the present invention is not limited thereto and may be changed and modified in various ways within a range equivalent to the spirit of the present invention and claims described below by those skilled in the art.

What is claimed is:

1. A method of coast regenerative brake cooperation control for rear wheels of an environment-friendly vehicle that adjusts braking forces of front wheels and rear wheels to adjust an S-braking value, which is the sum of a coast regenerative brake value and a rear-wheel regenerative brake value that are generated at the rear wheels, to be within a critical value set in advance for each deceleration section, the method comprising:
adjusting, by a controller, the S-braking value in a first section that is a section from an initial deceleration to a first reference deceleration such that a coast regenerative brake value that has been generated is fully allowed;
adjusting, by the controller, the S-braking value in a second section that is a section from the first reference deceleration to a second reference deceleration to decrease the coast regenerative brake value generated in the first section; and
adjusting, by the controller, the S-braking value in a third section that is a section from the second reference deceleration to a third reference deceleration to maintain or decrease the coast regenerative brake value decreased in the second section.

2. The method of claim 1, further comprising:
calculating, by the controller, the S-braking value and comparing the calculated S-braking value with the critical value in real time in the first section to the third section.

3. The method of claim 1, wherein the rear-wheel regenerative brake value is increased in the first section.

4. The method of claim 1, wherein the rear-wheel regenerative brake value is increased to prevent the S-braking value from exceeding the critical value in the second section.

5. The method of claim 1, wherein the critical value is set such that a wheel slip ratio that is generated at the rear wheels is within about 15%.

6. The method of claim 1, wherein the rear-wheel regenerative brake value is increased to prevent the S-braking value from exceeding the critical value in the third section.

7. The method of claim 6, further comprising:
adjusting, by the controller, in a fourth section, a rear-wheel regenerative braking value generated in the third section to be converted into a rear-wheel friction braking force after the third reference deceleration.

8. The method of claim 1, further comprising:
adjusting, by the controller, a front-rear-wheel braking distribution ratio of the third section to be a distribution ratio based on a coast regenerative brake value adjusted in the second section to a basic distribution ratio.

9. The method of claim 8, wherein when the coast regenerative brake value is fully decreased in the second section, the front-rear-wheel braking distribution ratio of the third section is adjusted to be the basic distribution ratio.
